(19) United States
(12) Patent Application Publication
(10) Pub. No.: US 2006/0233098 A1
(43) Pub. Date: Oct. 19, 2006

(54) Method for detecting object collisions in a computer-based game

(76) Inventor: James Michael McArdle, Austin, TX (US)

Correspondence Address: IBM CORPORATION (SWP);C/O SUITER WEST SWANTZ PC LLO, 14301 FNB PARKWAY, SUITE 220, OMAHA, NE, 68154-5299, US

(21) Appl. No.: 11/105,614

(22) Filed: Apr. 14, 2005

(51) Int. Cl. H04L 1/00

(52) U.S. Cl. 370/216

(57) ABSTRACT

The present invention is a method for detecting object collisions in a computing device-based game, which includes the steps of: calculating projected times of collision for each of a plurality of objects, the projected times of collision based on the speed and direction of travel of each object; storing the projected times of collision; decrementing the projected times of collision as the game progresses; and, indicating a collision when a projected time of collision is reached.

### FIELD OF THE INVENTION

The present invention relates to the field of interactive computer gaming and particularly to a method for detecting object collisions in a computing device-based game.

### BACKGROUND OF THE INVENTION

Collision detection is a foundation of interactive gaming. Accomplishing collision detection in a precise fashion enhances the gaming experience for a user by allowing a computing device in which the game is implemented to indicate collisions of game objects in an accurate and “real-time” manner. Many collision detection strategies have been developed to differentiate between a “real” collision and a “false” collision. However, prior strategies, such as pixel touching, have resulted in processor swamping. Further strategies, such as utilizing bounding rectangles, have not worked particularly well with the more sophisticated, three-dimensional graphics of today's games.

Therefore, it would be advantageous to have a method for collision detection that allows for rapid detection and indication of “real” collisions of objects in computer-based games.

### SUMMARY OF THE INVENTION

Accordingly, the present invention is directed to a method for detecting object collisions in a computing device-based game, which includes the steps of: calculating projected times of collision for each of a plurality of objects, the projected times of collision based on the speed and direction of travel of each object; storing the projected times of collision; decrementing the projected times of collision as the game progresses; and, indicating a collision when a projected time of collision is reached.

In a further embodiment, the present invention is directed to a method for detecting object collisions in a computing device-based game, which includes the steps of: calculating projected times of collision for each of a plurality of objects, the projected times of collision based on the speed and direction of travel of each object; storing the projected times of collision; setting a timer corresponding to an earliest projected time of collision; decrementing the timer as the game progresses; and, indicating a collision when the timer reaches a pre-determined value.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying FIGUREs in which:

FIG. 1 is a flowchart illustrating a method for detecting object collisions in a computing device-based game in accordance with an exemplary embodiment of the present invention;

FIG. 2 is a computing device for implementation of an exemplary embodiment of the method of the present invention;

FIG. 3 is a table of projected times of collision for a plurality of objects in accordance with an exemplary embodiment of the present invention;

FIG. 4 is a flowchart illustrating a method for detecting object collisions in a computing device-based game in accordance with an exemplary embodiment of the present invention; and,

FIG. 5 is an illustration of the effect of a user event upon a method for detecting object collisions in a computing device-based game in accordance with an exemplary embodiment of the present invention

### DETAILED DESCRIPTION OF THE INVENTION

Reference will now be made in detail to the presently preferred embodiments of the invention, examples of which are illustrated in the accompanying drawings.

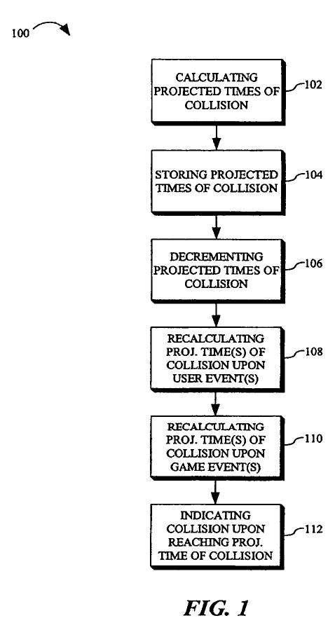

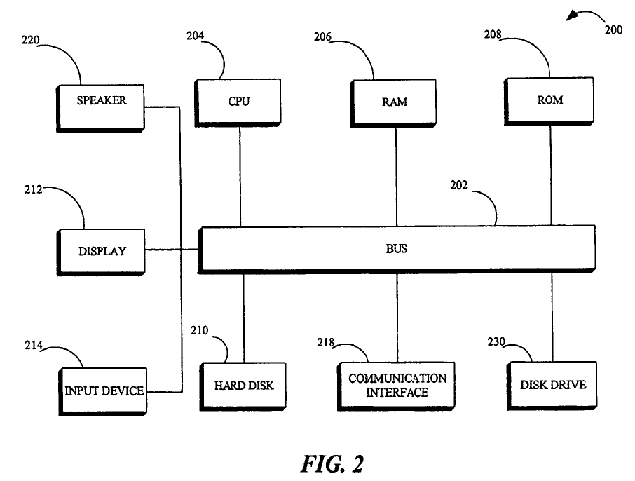

Referring generally to FIG. 1, a method for detecting object collisions in a computing device-based game 100 in accordance with an embodiment of the present invention is discussed. The method 100 includes calculating projected times of collision for each of a plurality of objects based on the speed and direction of travel for each object 102. In a present embodiment, a computing device-based game includes a plurality of objects which are displayed on a display of the computing device in which the game is implemented. For example, the game may be a football game having a plurality of moving objects, such as football players and a football, displayed on a display of the computing device. In an exemplary embodiment, as the game is being played, the computing device calculates projected times of collision (i.e.—the estimated time that must elapse before an object will collide with another object) for each object in the game based upon the speed and direction of travel for each object. Further, the computing device calculates the projected times of collision 102 based upon an assumption that the speed and direction of travel for each object at the time of calculation will remain constant. It is understood that a number of vector algebra techniques are known in the art which may be utilized to assist in making the above-referenced calculations. In a present embodiment, the computing device 200 is a personal computer as shown in FIG. 2. In further embodiments, the computing device is a hand-held interactive gaming system, a home video game system, or the like.

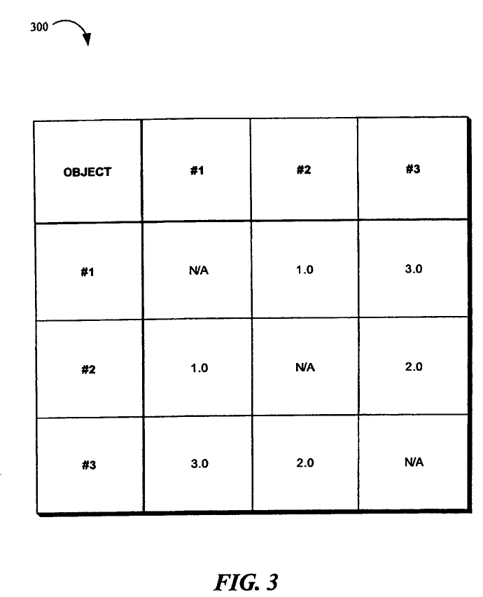

The method 100 further includes storing the projected times of collision 104. In a present embodiment, the projected times of collision for each object are stored 104 in a memory 206/208 of the computing device 200. In exemplary embodiments, the projected times of collision are stored 104 in a memory 206/208 of the computing device 200 in the form of a table, a matrix or the like. FIG. 3 illustrates a group 300 of projected times of collision for a plurality of objects, the projected times of collision stored in the form of a table.

The method 100 further includes decrementing the projected times of collision as the game progresses 106. For example, Object X and Object Y of a game are moving towards each other and are expected to collide (i.e.—have a projected time of collision) of 1.00 second. As the game progresses, and Object X and Object Y continue moving towards each other along the same path at the same rate of speed, the projected time of collision for Object X and Object Y will decrease. Therefore, the computing device will decrement the projected time of collision 106 for Objects X and Y accordingly. In a present embodiment, the projected times of collision will be decremented 106 by the computing device at periodic intervals. For instance, the projected times of collision may be decremented 106 by some amount at each redraw cycle (i.e.—the frequency with which the computing device redraws the screen as a game progresses). For example, if 1/10^{th} of a second elapses with each redraw cycle, the projected times of collision will be decremented by 1/10^{th} of a second at each redraw cycle. Therefore, after one redraw cycle or 1/10^{th} of a second has elapsed, the projected time of collision between Objects X and Y will be 0.90 seconds. Assuming Objects X and Y maintain their same respective speeds and directions of travel, the two objects are projected to collide when 0.90 seconds elapses, or upon the completion of nine more redraw cycles.

In the present embodiment, the method 100 further includes recalculating one or more projected times of collision upon the occurrence of one or more user events 108. For example, a user playing the game may change the speed or direction of travel of an object through manipulation of an input device 214 (FIG. 2), such as a joystick, a mouse or the like. Therefore, in response to such user events, the computing device will have to recalculate 108 its previously projected times of collision, which were calculated 102 based upon the assumption that the respective speeds and directions of travel for the objects would remain constant. For example, the computing device, utilizing the respective speed and direction of travel of Objects A and B, and assuming that Objects A and B will maintain their respective speeds and directions of travel, calculates 102 that Objects A and B will collide in 3 seconds. (i.e.—the projected time of collision between Objects A and B). As the game progresses, prior to the 3 second projected collision time for Objects A and B elapsing, a user applies a braking motion input via a joystick or mouse, which causes the speed of Object A to decrease. Upon the occurrence of the user event (i.e.—the applied braking motion), the computing device recalculates 108 the projected time of collision between Objects A and B, based on their respective speeds and directions of travel at the time of recalculation.

In the present embodiment, the method 100 further includes recalculating one or more projected times of collision upon the occurrence of one or more game events 110. For example, if a user is playing a computing device-based football game, the game may include a game event, such as a gust of wind, which alters the speed and direction of a moving object, such as a thrown football. Therefore, in response to the game event (i.e.—the gust of wind), the computing device will have to recalculate 110 its originally projected time of collision between for instance, the thrown football (a first object) and a wide receiver (a second object), because the wind is altering the speed and direction of the thrown football while the football is traveling through the air.

The method 100 further includes indicating a collision when a projected time of collision is reached 112. In an exemplary embodiment, a projected time of collision is reached upon the value of a projected time of collision reaching zero. In further embodiments, a projected time of collision is reached upon the value of a projected time of collision reaching a negative value. In a present embodiment, the computing device indicates a collision 112 visually via a connected display device 212. For example, a monitor connected with the computing device indicates a collision by displaying a visual or graphical depiction of two or more objects colliding. In a further embodiment, the computing device provides an audible indication that a collision has occurred via a connected audible indication device. For instance, an audible indication may be emitted via a speaker 220 connected with the computing device to indicate that two or more objects have collided, such as emitting a crunching sound when two players (i.e.—objects) collide in a computing device-based football game.

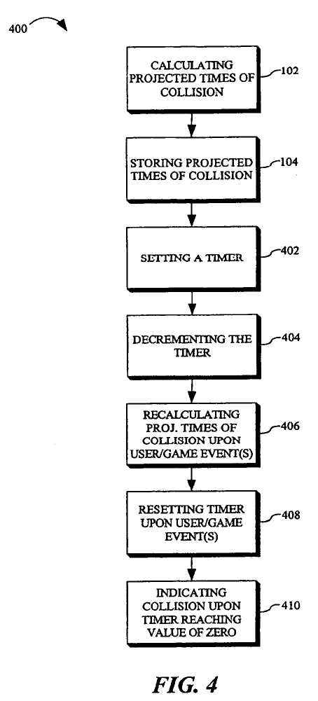

Referring generally to FIG. 4, a method for detecting object collisions in a computing device-based game 400 in accordance with an embodiment of the present invention is discussed. The method 400 includes calculating projected times of collision for each of a plurality of objects based on the speed and direction of travel for each object 102. In an exemplary embodiment, as the game is being played, the computing device calculates projected times of collision for each object in the accompanying game. Further, the computing device calculates the projected times of collision 102 based upon an assumption that the speed and direction of travel for each object at the time of calculation will remain constant. The method 400 further includes storing the projected times of collision 104. In a present embodiment, the projected times of collision for each object are stored 104 in a memory 206/208 (FIG. 2) of the computing device 200 in the form of a table.

The method 400 further includes setting a timer corresponding to an earliest projected time of collision 402. In an exemplary embodiment, a memory 206/208 (FIG. 2) of the computing device 200 includes a timer. The computing device sets the timer 402 to correspond to the earliest projected time of collision. The method 400 further includes decrementing the timer as the game progresses 404. For instance, if the earliest projected time of collision of any two or more objects in a game is 3 seconds, the computing device will set the timer to 3 seconds and, as the game progresses, will decrement the timer 404 as the 3 seconds elapses.

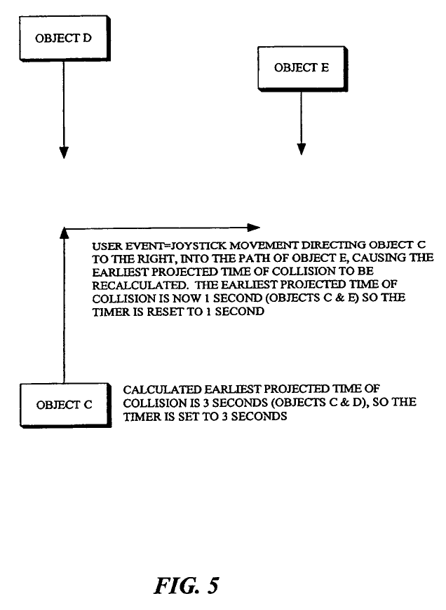

In the present embodiment, one or more projected times of collision are recalculated 406 and the timer is reset 408 upon the occurrence of one or more user events. FIG. 5 illustrates the effect of a user event upon the projected times of collision. For example, the computing device calculates projected times of collision for each object 102. According to the calculations, the earliest projected time of collision for any two or more objects in the game is 3 seconds, the projected time of collision for Objects C and D. Thus, the computing device sets the timer 402 to 3 seconds and begins decrementing the timer 404. As the game progresses, and prior to the 3 seconds elapsing, a user playing the game changes the speed or direction of travel of Object C with respect to Object D, via a user event, such as manipulation of a joystick, a mouse or the like. Upon the occurrence of the user event, the computing device recalculates the projected times of collision for each object, with respect to C or D, interacting in the game 406. In the present example, after recalculation of the projected times of collision 406, the earliest projected time of collision for any two or more objects in the game is 1 second, the projected time of collision between Object C and Object E. Therefore, the computing device resets the timer to 1 second to correspond to the newly calculated earliest projected collision time and begins decrementing the timer 404.

In the present embodiment, one or more of the projected times of collision are recalculated 406 and the timer is reset 408 upon the occurrence of one or more game events. For example, the computing device calculates the projected times of collision for each object in a game 102. The earliest projected time of collision for any 2 or more objects in the game is 3 seconds, the projected time it will take for objects J and K to collide. The computing device sets the timer 402 to 3 seconds and begins decrementing the timer 404. Upon a game event, such as objects J and K colliding, the speed and direction of travel for objects J and K will change. Therefore, the computing device will have to recalculate the projected times of collision for each object, with respect to J or K, interacting in the game 406 to determine a new, earliest projected time of collision. The computing device will also have to reset the timer 408 to correspond to the newly calculated earliest projected time of collision and begin decrementing the timer 404.

The method 400 further includes indicating a collision when the timer reaches a value of zero 410. In an exemplary embodiment, upon the timer reaching a value of zero, the computing device indicates a collision 410 visually via a connected display device 212. In a further embodiment, the computing device provides an audible indication that a collision has occurred via a connected audible indication device, such as a speaker 220.

In an exemplary embodiment, the step of decrementing the timer 404 is done by separate hardware of the computing device 200 from the hardware which performs the other steps of the method 400. For example, upon the occurrence of one or more user/game events, an interrupt is sent to the CPU 204, which notifies the CPU 204 that the projected times of collision need to be recalculated 406 or that a collision needs to be indicated 410.

It is important to note that while the present invention has been described as a method, those skilled in the art will appreciate that the method of the present invention is capable of being distributed in the form of a computer-readable medium of instructions in a variety of forms, and that the present invention applies equally, regardless of the particular type of signal bearing media utilized to carry out the distribution. Examples of computer readable media include: non-volatile, hard-coded type media such as read only memories (ROMs) or erasable, electrically programmable read only memories (EEPROMs), recordable-type media such as floppy disks, hard disk drives and CD-ROMs and transmission-type media such as digital and analog communication links.

It is believed that the method of the present invention and many of its attendant advantages will be understood by the forgoing description. It is also believed that it will be apparent that various changes may be made in the form, construction and arrangement of the steps or elements thereof without departing from the scope and spirit of the invention or without sacrificing all of its material advantages. The form herein before described being merely an explanatory embodiment thereof.

What is claimed is:

1. A method for detecting object collisions in a computing device-based game, comprising:
calculating projected times of collision for each of a plurality of objects, the projected times of collision based on the speed and direction of travel of each object;
storing the projected times of collision;
decrementing the projected times of collision as the game progresses; and,
indicating a collision when a projected time of collision is reached.

2. A method as claimed in claim 1, wherein each of the projected times of collision are calculated based upon a constant speed and direction of travel of an object.

3. A method as claimed in claim 1, wherein each of the projected times of collision are stored in a memory of the computing device in the form of a table.

4. A method as claimed in claim 1, wherein each of the projected times of collision are decremented at each redraw cycle by an amount of time elapsing between each redraw cycle.

5. A method as claimed in claim 1, wherein one or more of the projected times of collision are recalculated upon the occurrence of one or more user events.

6. A method as claimed in claim 1, wherein one or more of the projected times of collision are recalculated upon the occurrence of one or more game events.

7. A method as claimed in claim 1, wherein indicating a collision is achieved visually via a display device connected with the computing device.

8. A method as claimed in claim 1, wherein indicating a collision is achieved by an audible indication via an audible indication device connected with the computing device.

9. A method for detecting object collisions in a computing device-based game, comprising:
calculating projected times of collision for each of a plurality of objects, the projected times of collision based on the speed and direction of travel of each object;
storing the projected times of collision;
setting a timer corresponding to an earliest projected time of collision;
decrementing the timer as the game progresses; and,
indicating a collision when the timer reaches a pre-determined value.

10. A method as claimed in claim 9, wherein each of the projected times of collision are calculated based upon a constant speed and direction of travel of an object.

11. A method as claimed in claim 9, wherein each of the projected times of collision are stored in a memory of the computing device in the form of a table.

12. A method as claimed in claim 9, wherein one or more projected times of collision are recalculated upon the occurrence of one or more of a user event and a game event.

13. A method as claimed in claim 12, wherein upon one or more of the projected times of collision being recalculated, the timer is reset to correspond to an earliest projected time of collision.

14. A method as claimed in claim 9, wherein indicating a collision is achieved visually via a display device connected with the computing device.

15. A program within a computer-readable medium for detecting object collisions in a computer-based game, comprising:
instructions within the computer-readable medium for causing the computer to calculate projected times of collision for each of a plurality of objects, the projected times of collision based on the speed and direction of travel of each object;
instructions within the computer-readable medium for causing the computer to store the projected times of collision in a memory of the computer;
instructions within the computer-readable medium for causing the computer to decrement the projected times of collision as the game progresses; and,
instructions within the computer-readable medium for causing the computer to indicate a collision, via one or more indication devices connected with the computer, when a projected time of collision is reached.

16. A program as claimed in claim 15, wherein the projected times of collision are stored in the form of a table.

17. A program as claimed in claim 15, wherein each of the projected times of collision are decremented at each redraw cycle by an amount of time elapsing between each redraw cycle.

18. A program as claimed in claim 15, wherein instructions are included within the computer-readable medium for causing the computer to recalculate one or more of the projected times of collision upon the occurrence of one or more user events.

19. A program as claimed in claim 15, wherein instructions are included within the computer-readable medium for causing the computer to recalculate one or more of the projected times of collision upon the occurrence of one or more game events.

20. A program as claimed in claim 15, wherein a projected time of collision is reached upon a projected time of collision having a value of zero.
